(19) United States
(12) Patent Application Publication
(10) Pub. No.: US 2021/0086494 A1
(43) Pub. Date: Mar. 25, 2021

(54) Layer Structures, Constructs, And Methods Of Forming And Using The Same

(71) Applicant: Graphic Packaging International, LLC, Atlanta, GA (US)

(72) Inventors: Ryan Portrey, Louisville, CO (US); Jeffrey T. Sloat, Broomfield, CO (US)

(21) Appl. No.: 17/025,122

(22) Filed: Sep. 18, 2020

Related U.S. Application Data
(60) Provisional application No. 62/903,262, filed on Sep. 20, 2019.

(51) Int. Cl. B32B 29/06; B65D 65/42; D21H 27/10

(52) U.S. Cl. CPC B32B 29/06; D21H 19/822; D21H 27/10; B65D 65/42

(57) ABSTRACT

A layer structure includes a substrate, a clay coating applied to the substrate, and a high performance coating applied to the clay coating, the high performance coating is configured to be thermally stable when subject to heating in either of a conventional oven and a microwave oven.

### CROSS-REFERENCE TO RELATED APPLICATION

This application claims the benefit of U.S. Provisional Patent Application No. 62/903,262, filed on Sep. 20, 2019.

### INCORPORATION BY REFERENCE

The disclosure of U.S. Provisional Patent Application No. 62/903,262, filed on Sep. 20, 2019, is hereby incorporated by reference for all purposes as if presented herein in its entirety.

### BACKGROUND OF THE DISCLOSURE

The present disclosure generally relates to layer structures for forming constructs for holding one or more food products. More specifically, the present disclosure relates to a layer structure for forming a construct for holding one or more food products and that includes a high performance coating that provides the layer structure with a configuration suitable for heating according to multiple modalities, for example, conventional ovens and microwave ovens.

### SUMMARY OF THE DISCLOSURE

According to one aspect, a layer structure comprises a substrate, a clay coating applied to the substrate, and a high performance coating applied to the clay coating, the high performance coating is configured to be thermally stable when subject to heating in either of a conventional oven and a microwave oven.

According to another aspect, a construct for holding at least one food product comprises a press-formed layer structure comprising a bottom and at least one sidewall extending upwardly from the sidewall and extending at least partially around an interior of the construct. The layer structure comprises, a substrate, a clay coating applied to the substrate, and a high performance coating applied to the clay coating, the high performance coating is configured to be thermally stable when subject to heating in either of a conventional oven and a microwave oven.

According to another aspect, a method of forming a layer structure comprises obtaining a substrate, applying a clay coating to the substrate, and applying a high performance coating to the clay coating so that the high performance coating is thermally stable when subject to heating in either of a conventional oven and a microwave oven.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a schematic cross-sectional view of a layer structure according to an exemplary embodiment of the disclosure.

FIG. 2 is a schematic cross-sectional view of an alternative configuration of the layer structure of FIG. 1.

FIG. 3 is a plan view of a blank formed from the layer structure of FIG. 1 and for forming a construct according to an exemplary embodiment of the disclosure.

FIG. 4 is a perspective view of a construct formed from the blank of FIG. 3 according to an exemplary embodiment of the disclosure.

FIG. 5 is a perspective view of an alternative configuration of the construct of FIG. 4.

FIG. 6 is a perspective view of a construct formed from the layer structure of FIG. 1 according to another exemplary embodiment of the disclosure.

FIG. 7 is a perspective view of a construct formed from the layer structure of FIG. 1 according to another exemplary embodiment of the disclosure.

Corresponding parts are designated by corresponding reference numbers throughout the drawings.

### DETAILED DESCRIPTION OF THE EXEMPLARY EMBODIMENTS

Various aspects of the disclosure may be understood further by referring to the figures. For purposes of simplicity, like numerals may be used to describe like features. It will be understood that where a plurality of similar features are depicted, not all of such features necessarily are labeled on each figure. It also will be understood that the various components used to form the constructs may be interchanged. Thus, while only certain combinations are illustrated herein, numerous other combinations and configurations are contemplated hereby.

Constructs according to the present disclosure can accommodate articles of numerous different shapes. For the purpose of illustration and not for the purpose of limiting the scope of the disclosure, the following detailed description describes articles such as food products at least partially disposed within the construct embodiments. In this specification, the terms “lower,” “bottom,” “upper”, “top”, “front”, and “back” indicate orientations determined in relation to fully erected constructs.

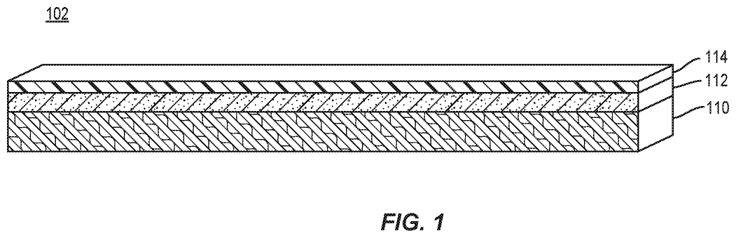

Referring to FIG. 1, a schematic cross-sectional view of a material layer or blank or layer structure 102 for forming a construct is illustrated according to an exemplary embodiment of the disclosure. Such a construct can be used to hold one or more food products, for example, rice, biscuits, fruits, vegetables, soups, pasta, etc. Such food products can be frozen or non-frozen foods that may be provided in discrete portions. As described herein, the layer structure 102 and the constructs formed therefrom are provided with a high performance coating 114 that is configured to substantially maintain consistent material properties both when exposed to high temperatures during heating in a conventional oven as well as heating and resultant temperatures from incident microwave radiation in a microwave oven.

Still referring to FIG. 1, the layer structure 102 can include a base layer or substrate 110 that can be formed from a composite material, e.g., a paper product such as a paperboard, or another fiber-based material. As described herein, the substrate 110 supports and/or provides an attachment structure or attachment surface for other layers/components of the layer structure 102.

As shown, a clay coating 112 (broadly, “first clay coating”) can be provided upon at least one surface of the substrate 110. The clay coating 112, in one embodiment, can be a mineral substance, such as refined clay, examples of which can include Kaolinite, calcium carbonate, Bentonite, talc, etc.

The clay coating 112 can provide desirable surface properties to at least a portion of the layer structure 102. For example, the clay coating 112 can be disposed in an arrangement interspersed with gaps and/or protrusions of the fibrous material that makes up the substrate 110. Such arrangement of the clay coating 112 can provide a substantially smooth/continuous surface on the substrate 110. In addition, the presence of the clay coating 112 can provide a suitable surface for receiving optional inks or other printed indicia, for example, for product information, advertising information, or other information or images. In one embodiment, the clay coating 112 can provide/enhance desired structural properties of the laminate structure 102, for example, rigidity, resistance to bending or buckling, etc.

Still referring to FIG. 1, the layer structure 102 can include the high performance coating 114 positioned on the clay coating 112. The high performance coating 114 can be deposited on the clay coating 112, for example, through roll coating (e.g., with a gravure, rod, flexographic apparatus, etc.) and/or flow coating. In one embodiment, the high performance coating 114 can be applied to the clay coating 112 through another application process, such as spray application, dipping, vapor deposition, extrusion, pressing, stamping, or another form of lamination.

The clay coating 112, in addition to the overall advantages provided to the layer structure 102 described above, can provide a desirable surface for receiving the high performance coating 114, e.g., by providing a substantially smooth and continuous surface for receiving the high performance coating 114, by providing a desirable interface between the clay coating 112 and the high performance coating 114, etc. In one embodiment, the high performance coating 114 can be applied directly to the substrate 110.

The high performance coating 114 can provide barrier properties against fluids, e.g., so as to minimize, inhibit, and/or prevent the passage of fluids to the substrate 110, such as grease/oil, food runoff, condensation, etc. In addition, the high performance coating 114 can be a food-contacting or food-facing surface that defines an interior of various constructs that can be formed form the layer structure 102. In this regard, the high performance coating can be comprised of a material suitable for momentary or prolonged contact with food products, e.g., an FDA-compliant material.

Further still, the high performance coating 114 can be comprised of a thermally stable or thermally resilient material, e.g., a material the can substantially maintain its material and structural properties (e.g., stiffness, viscosity, dimensional properties, etc.) in heating environments that include a conventional oven and a microwave oven.

In one embodiment, the high performance coating 114 can be thermally stable/thermally resilient in a conventional oven at temperatures up to and including about 450° F., e.g., from about 400° F. (204° C.) to about 450° F. (232° C.), such as about 425° F. (218° C.). The high performance layer 114 can also withstand temperatures in a microwave oven of up to and including about 400° F. (204° C.), for example, temperatures from about 300° F. (148° C.) and to about 400° F. (204° C.).

It is noted that in microwave heating environments, incident microwave radiation can cause excitation of molecules associated with a food product in a manner such that rapid increases of temperature can occur on, within, or near the layer structure 102 or constructs formed therefrom. However, the high performance coating 114 is configured to be thermally stable/thermally resilient in such rapidly heated regions, for example, regions in which a change in temperature, ΔT, is between about 40° F. (4° C.) per second and about 125° F. (51° C.) per second. Such thermal stability/thermal resiliency in the presence of a high ΔT is advantageous as compared to, for example, a layer or coating on a conventional layer structure or laminate structure that softens, warps, shrinks, or otherwise deforms in the presence of a high ΔT.

The high performance coating 114 can be a liquid coating, a polymeric sheet/layer, or another material suitable for application to the clay coating 112. In one embodiment, the high performance coating 114 can provide a liquid barrier that minimizes, inhibits, and/or prevents grease/oil and/or moisture penetration. In another embodiment, the high performance coating 114 can be a liquid coating that provides the aforementioned protection against grease/oil and/or moisture penetration, in addition to providing a surface suitable for contact with a film, e.g., a heat sealable lid film.

It will be understood that the layer structure 102 can have a different configuration without departing from the disclosure. For example, adhesive can be applied to one or more surfaces of any one of the base 110, the clay coating 112, and the high performance coating 114 to facilitate formation and/or maintenance of the arrangement of the layer structure 102. As another example, additional layers or materials can be provided in addition or in substitution for any of the above-described components, e.g., a microwave energy interactive material such as a susceptor.

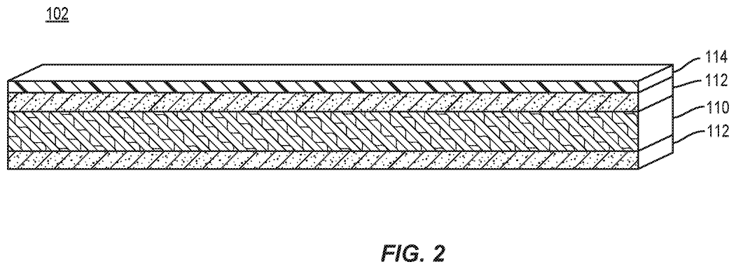

Turning to FIG. 2, an alternative configuration of the layer structure 102 is illustrated, in which an additional clay coating 112 (broadly, “second clay coating”) is applied to an exterior surface of the base 110. The clay coating 112 on the exterior surface of the base 110, as described above, can provide a suitable surface for receiving optional inks or other printed indicia, for example, for product information, advertising information, or other information or images. In addition, the clay coating 112 on the exterior surface of the base 110 can provide desirable surface and structural properties in accordance with the discussion above.

As described herein, the layer structure 102 includes at least the base 110, one or more clay coating 112, and the high performance coating 114. It will be understood that the layer structure 102 can be provided in a differing sizes and/or shapes to suit desired applications.

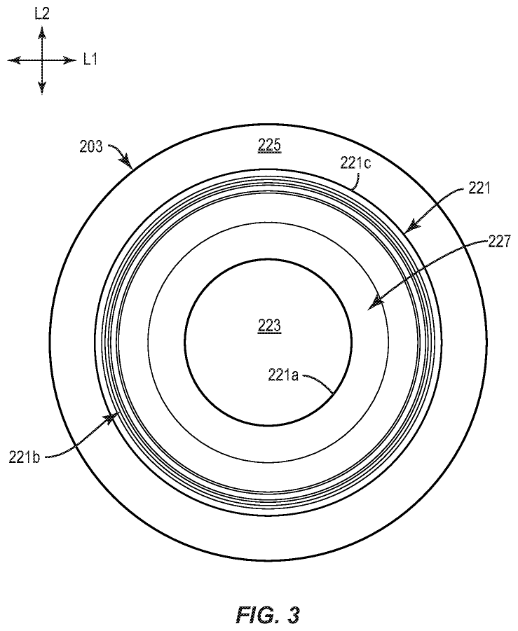

Referring now to FIG. 3, a blank for forming a construct 205 from the layer structure 102 according to an exemplary embodiment of the disclosure is generally designated 203. The blank 203 has a longitudinal axis L1 and a lateral axis L2, and can be a generally circular arrangement of the layer structure 102.

The blank 203 can be provided with concentric and generally circular lines of weakening 221, as shown, that can facilitate formation of the blank 203 into the construct 205, as described further herein. In the illustrated embodiment, the lines of weakening 221 can include at least an innermost central circular line of weakening 221a that defines and circumscribes a central region 223 of the blank 203 therein, an outermost circular line of weakening 221c that defines a peripheral portion 225 of the blank 203 between the line of weakening 221c and a free edge of the blank 203, and one or more intermediate circular lines of weakening 221b disposed along an intermediate region 227 of the blank 203 that is defined between the outermost circular line of weakening 221c and the innermost circular line of weakening 221a. In one embodiment, the intermediate lines of weakening 221b can include seven concentric circular lines of weakening disposed relative to each other at non-uniform intervals, though it will be understood that the intermediate lines of weakening 221b can include a greater or fewer number of lines of weakening, in different arrangements, without departing from the disclosure.

In one embodiment, the blank 203 can be positioned in a forming apparatus for forming the construct 205. Such forming apparatus can include, for example, a mold that defines a cavity within which the blank 203 can be at least partially received. Accordingly, the mold can be provided with an arrangement that is complementary to a die that is at least partially inserted into the cavity of the mold to influence the formation of the construct 205 from the blank 203.

In this regard, such a mold of an apparatus for forming the construct 205 can include a bottom upon which at least a portion of the central region 223 of the blank 203 can positioned, a sidewall extending upwardly from the bottom and upon which at least a portion of the intermediate region 227 of the blank 203 can be positioned, and an upper ledge circumscribing the cavity of the mold and upon which at least a portion of the peripheral portion 225 of the blank 203 can be positioned. The mold can one or more recesses, protrusions, other surface features, etc., to facilitate the eventual separation of the blank 203/construct 205 from the mold, to receive a portion of a die, etc.

In this regard, the blank 203 can thus be positioned relative to a mold such that when a die is at least partially inserted toward and into the cavity of the mold, the blank 203 at least partially conforms to the shape defined by the mold.

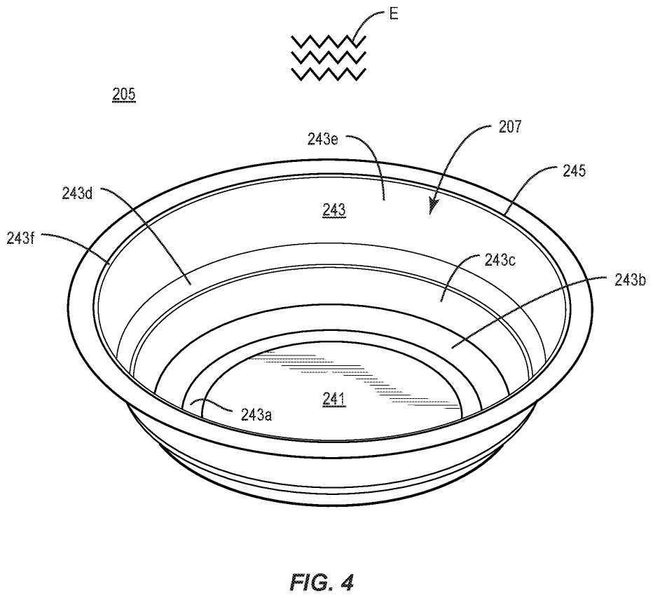

Turning to FIG. 4, the construct 205 formed from the blank 203 is illustrated. As shown, and as can be provided by the formation described above, the construct 205 can be in the form of a generally circular tray that includes a bottom 241 formed from the central portion 223 of the blank 203, a sidewall 243 can be formed from the intermediate portion 227 of the blank 203 and extends upwardly from the bottom 241, and a flange 245 can be formed from the peripheral portion 225 of the blank 203 and positioned to extend outwardly from the sidewall 243.

The sidewall 243 and the bottom 241 of the construct 205 define an interior 207 of the construct 205 that can receive a food product, for example, rice, biscuits, fruits, vegetables, soups, pasta, etc. Such food products can be frozen or non-frozen foods that may be provided in discrete portions.

In the illustrated embodiment, the sidewall 243 of the construct 205 can include ascending segments 243a, 243b, 243c, 243d, 243e, 243f that transition at curves, ridges, ledges, bumps, etc. defined by the circular lines of weakening 221 (FIG. 3). A different number and configuration of segments and associated features of the sidewall 243 can be provided, or the sidewall 243 can have a substantially uniform arrangement, without departing from the disclosure.

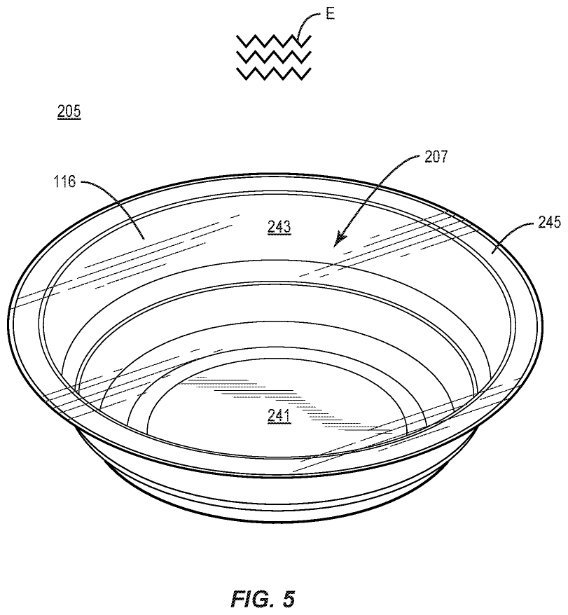

Referring to FIG. 5 an alternative configuration of the construct 205 is illustrated, and in which a film layer 116 is applied to the flange 245 of the construct 205 to extend across the top of the interior 207 of the construct 205, e.g., to maintain a desired sanitary environment of food products held in the interior 207 of the construct 205.

In one embodiment, the film layer 116 can be formed from a polymeric material that is provided with barrier properties that minimize, inhibit, and/or prevent the passage of fluids and particulate therethrough, e.g., to maintain a desired sanitary environment for food products supported in the interior 207 of the construct 205.

Accordingly, in one embodiment, the film layer 116 can be applied to one or more portions of the flange 245 of the construct 205. It will be understood that the film layer 116 can be applied to the blank 203, for example, the peripheral portion 225 of the blank 203, prior to or during formation of the construct 205. In this regard, the construct 205 can be applied to the high performance coating 114 of the layer structure 102 described above. The high performance coating 114 can provide a suitable desirable surface upon which the lid or film layer 116 can be applied, e.g., such that the high performance coating 114 has an enhanced capacity for adhesion to the film layer 116. It will be understood that the lid or film layer 116 can be provided without the additional clay coating 112 on the exterior surface of the base 110.

As described above, the construct 205 can be formed from the layer structure 102 such that the high performance coating 114 forms the interior surface of the construct 205 and defines the interior 207 of the construct 205. In this regard, the construct 205 can be exposed to microwave energy E and high temperatures or ΔT associated with microwave cooking, and the high performance layer 114 can maintain its thermal stability/thermal resilience, as described above.

The above-described configuration of the construct 205 is suitable for providing multiple constructs 205 in a nested arrangement to form a system. For example, the sidewall 243 and the bottom 241 of an upper construct 205 can be at least partially positioned within the interior 207 of a construct 205 positioned therebelow. In this regard, the exterior surface of the sidewall 243 of the upper construct 205 can conform and nest with the complementary interior surfaces of the sidewall 243 of the lower construct 205. In this regard, the flange 245 of the upper construct 205 can be generally aligned with the flange 245 of the lower construct 205, and the constructs 205 can be dimensioned and arranged such that a gap can be defined therebetween. Such a gap can be presented to facilitate separation of nested constructs 205, for example, manually or through a tool such as a separating knife or blade, clamp or pincer, machine finger, etc.

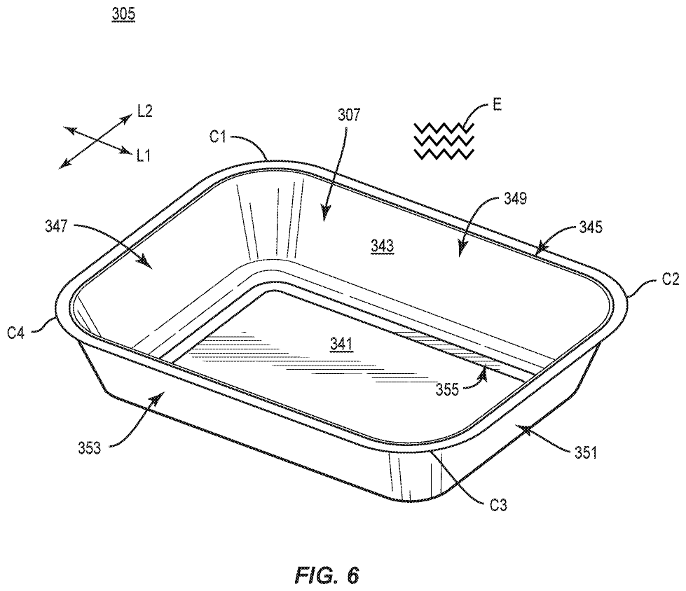

Referring additionally to FIG. 6. another construct that can be formed from the layer structure 102 according to an exemplary embodiment of the disclosure is generally designated 305.

The construct 305, as shown, has the form of a tray with a generally rectangular or rounded rectangular configuration having a longitudinal axis L1 and a lateral axis L2, and can be formed from the layer structure 102 in a forming apparatus as described above with respect to the construct 205. As shown, the construct 305 has a bottom/bottom wall/bottom panel 341, a sidewall 343 that extends upwardly from the bottom 341 such that the bottom 341 and the sidewall 343 define an interior 307 of the construct 305, and a flange 345 extending outwardly from the sidewall 343.

The sidewall 343 of the construct 305 can be arranged so as to define a first lateral end portion or first lateral side portion 347, a first longitudinal side portion 349, a second lateral end or second lateral side portion 351, and a second longitudinal side portion 353, which intersect at respective curved corners C1, C2, C3, C4. The respective sides 347, 349, 351, 353 and the respective corners C1, C2, C3, C4 of the construct 305 can transition at respective seams or ridges, or can transition along a substantially uninterrupted surface configuration.

In this regard, the bottom 341 of the construct 305 can include a channel 355 that is a recessed portion in the interior 307 of the construct 305 that presents a protrusion on a bottom exterior portion of the construct 305. Such protrusion can provide a feature that supports the remainder of the bottom 341 above a surface (e.g., to provide ventilation), to receive and provide a receptacle for oil/grease, food runoff, or other moisture that is positioned away from a food product in the interior 307 of the construct 305, to facilitate nesting of multiple constructs 305, etc.

In one embodiment, and as described above, the film layer 116 (FIG. 5) can be applied to the flange 345 of the construct 305 and extend across the top of the interior 307 of the construct 305, e.g., to maintain a desired sanitary environment of food products held in the interior 307 of the construct 305.

As described above, the construct 305 can be formed from the layer structure 102 such that the high performance coating 114 forms the interior surface of the construct 305 and defines the interior 307 of the construct 305. In this regard, the construct 305 can be exposed to microwave energy E and high temperatures or ΔT associated with microwave cooking, and the high performance coating 114 can maintain its thermal stability/thermal resilience, as described above.

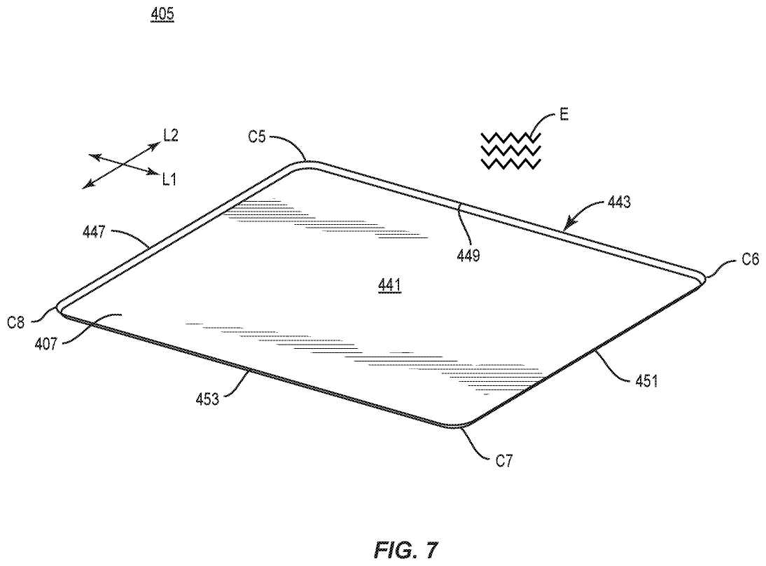

Turning to FIG. 7, another construct that can be formed from the layer structure 102 according to an exemplary embodiment of the disclosure is generally designated 405.

The construct 405, as shown, has the form of a tray with a generally rectangular or rounded rectangular configuration having a longitudinal axis L1 and a lateral axis L2, and can be formed from the layer structure 102 in a forming apparatus as described above with respect to the constructs 205, 305. As shown, the construct 405 has a bottom/bottom wall/bottom panel 441, a sidewall 443 that extends upwardly from the bottom 441 such that the bottom 441 and the sidewall 443 define an interior 407 of the construct 405. While the construct 405 is illustrated without a flange, it will be understood that the construct 405 can be provided with a flange along one or more portions thereof without departing from the disclosure.

The sidewall of the construct 405 can be arranged so as to define a first lateral end or first lateral side 447, a first longitudinal side 449, a second lateral end or second lateral side 451, and a second longitudinal side 453, which intersect at respective curved corners C5, C6, C7, C8. The respective sides 447, 449, 451, 453 and the respective corners C5, C6, C7, C8 of the construct 405 can transition at respective seams or ridges, or can transition along a substantially uninterrupted surface configuration.

In one embodiment, and as described above, the film layer 116 (FIG. 5) can be applied to a portion of the construct 405, e.g., an upper edge of the sidewall 443, so as to extend across the top of the interior 407 of the construct 405, e.g., to maintain a desired sanitary environment of food products held in the interior 407 of the construct 405.

As described above, the construct 405 can be formed from the layer structure 102 such that the high performance coating 114 forms the interior surface of the construct 405 and defines the interior 407 of the construct 405. In this regard, the construct 405 can be exposed to microwave energy E and high temperatures or ΔT associated with microwave cooking, and the high performance coating 114 can maintain its thermal stability/thermal resilience, as described above.

In general, any blank/layer structure as described above may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating, as described herein. The clay coating may then be printed over with product, advertising, and other information or images, as described herein. The blank may then be coated with a varnish to protect information printed on the blanks. The blank may also be coated with, for example, a moisture barrier layer, on either or both sides of the blanks. The blank can also be laminated to or coated with one or more sheet-like materials at selected panels or panel sections.

In accordance with the exemplary embodiments, a line of weakening or fold line can be any substantially linear, although not necessarily straight, form of weakening that facilitates folding therealong. More specifically, but not for the purpose of narrowing the scope of the present disclosure, lines of weakening and fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more laminate layers adhered together by glue. The term “glue” is intended to encompass all manner of adhesives commonly used to secure laminate layers in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A layer structure, comprising:
a substrate;
a clay coating applied to the substrate; and
a high performance coating applied to the clay coating, the high performance coating is configured to be thermally stable when subject to heating in either of a conventional oven and a microwave oven.

2. The layer structure of claim 1, wherein the high performance coating is configured to be thermally stable when subject to heating at temperatures from 300° F. (149° C.) to 450° F. (232° C.).

3. The layer structure of claim 2, wherein the high performance coating is configured to be thermally stable when subject to heating at temperatures from 400° F. (204° C.) to 450° F. (232° C.).

4. The layer structure of claim 2, wherein the high performance coating is configured to be thermally stable when subject to heating at temperatures from 300° F. (149° C.) to 400° F. (204° C.) in a microwave oven and when subject to heating at temperatures from 400° F. (204° C.) to 450° F. (232° C.) in a conventional oven.

5. The layer structure of claim 2, wherein the high performance coating is configured to be thermally stable when subject to heating at a rate of temperature change from 40° F. (4° C.) per second to 125° F. (52° C.) per second.

6. The layer structure of claim 2, wherein the high performance coating is a liquid barrier coating.

7. The layer structure of claim 2, wherein the high performance coating is a polymeric coating.

8. The layer structure of claim 2, wherein the substrate comprises paperboard.

9. The layer structure of claim 8, wherein the clay coating is a first clay coating applied to an interior surface of the substrate, and the layer structure further comprises a second clay coating applied to an exterior surface of the substrate.

10. A construct for holding at least one food product, comprising:
a press-formed layer structure comprising a bottom and at least one sidewall extending upwardly from the sidewall and extending at least partially around an interior of the construct, the layer structure comprising:
a substrate;
a clay coating applied to the substrate; and
a high performance coating applied to the clay coating, the high performance coating is configured to be thermally stable when subject to heating in either of a conventional oven and a microwave oven.

11. The construct of claim 10, wherein the high performance coating is configured to be thermally stable when subject to heating at temperatures from 300° F. (149° C.) to 450° F. (232° C.).

12. The construct of claim 11, wherein the high performance coating is configured to be thermally stable when subject to heating at temperatures from 400° F. (204° C.) to 450° F. (232° C.).

13. The construct of claim 11, wherein the high performance coating is configured to be thermally stable when subject to heating at temperatures from 300° F. (149° C.) to 400° F. (204° C.) in a microwave oven and when subject to heating at temperatures from 400° F. (204° C.) to 450° F. (232° C.) in a conventional oven.

14. The construct of claim 11, wherein the high performance coating is configured to be thermally stable when subject to heating at a rate of temperature change from 40° F. (4° C.) per second to 125° F. (52° C.) per second.

15. The construct of claim 11, wherein the high performance coating is a liquid barrier coating.

16. The construct of claim 11, wherein the high performance coating is a polymeric coating.

17. The construct of claim 11, wherein the substrate comprises paperboard.

18. The construct of claim 17, wherein the clay coating is a first clay coating applied to an interior surface of the substrate, and the layer structure further comprises a second clay coating applied to an exterior surface of the substrate.

19. A method of forming a layer structure, the method comprising:
obtaining a substrate;
applying a clay coating to the substrate; and
applying a high performance coating to the clay coating so that the high performance coating is thermally stable when subject to heating in either of a conventional oven and a microwave oven.

20. The method of claim 19, wherein the high performance coating is configured to be thermally stable when subject to heating at temperatures from 300° F. (149° C.) to 450° F. (232° C.).

21. The method of claim 20, wherein the high performance coating is configured to be thermally stable when subject to heating at temperatures from 400° F. (204° C.) to 450° F. (232° C.).

22. The method of claim 20, wherein the high performance coating is configured to be thermally stable when subject to heating at temperatures from 300° F. (149° C.) to 400° F. (204° C.) in a microwave oven and when subject to heating at temperatures from 400° F. (204° C.) to 450° F. (232° C.) in a conventional oven.

23. The method of claim 20, wherein the high performance coating is configured to be thermally stable when subject to heating at a rate of temperature change from 40° F. (4° C.) per second to 125° F. (52° C.) per second.

24. The method of claim 20, wherein the high performance coating is a liquid barrier coating.

25. The method of claim 20, wherein the high performance coating is a polymeric coating.

26. The method of claim 20, wherein the substrate comprises paperboard.

27. The method of claim 26, wherein the clay coating is a first clay coating applied to an interior surface of the substrate, and the layer structure further comprises a second clay coating applied to an exterior surface of the substrate.

28. The method of claim 19, wherein the applying the high performance coating to the clay coating includes roll coating the high performance coating on the clay coating.

29. The method of claim 19, wherein the applying the high performance coating to the clay coating includes flow coating the high performance coating on the clay coating.
